(19) United States
(12) Patent Application Publication
(10) Pub. No.: US 2011/0113439 A1
(43) Pub. Date: May 12, 2011

(54) METHOD OF ELECTRONIC VOTING, DECODER FOR IMPLEMENTING THIS METHOD, AND NETWORK COMPRISING A VOTING SERVER FOR IMPLEMENTING THE METHOD

(76) Inventors: Gérard Delegue, Nozay (FR); Olivier Martinot, Nozay (FR)

(21) Appl. No.: 12/988,060

(22) PCT Filed: Apr. 6, 2009
(86) PCT No.: PCT/FR09/50579

§ 371 Date: Jan. 5, 2011

(30) Foreign Application Priority Data
Apr. 17, 2008 (FR) 0802133

(51) Int. Cl. H04N 7/16; H04L 9/32; G06F 21/00; H04N 7/173

(52) U.S. Cl. 725/1; 726/10; 725/24

(57) ABSTRACT

Method of electronic voting in a questionnaire, comprising:
a step of broadcasting an offer of electronic voting service to a plurality of communications terminals;
a step of sending, from a voter's communication terminal, a request to a remote server, this request containing information for authenticating a voter;
a step of authenticating the voter by comparing the authentication information received with recorded information associated with the voter;
when the voter has been authenticated, a step of dispatching to the communication terminal of the voter ticket to participate in the vote;
a step of dispatching the vote to the server, the former containing a response to the questionnaire and the ticket to participate in the vote,
   this method is characterized in that it comprises two steps of anonymization, a first step ensuring anonymization to the ticket to participate sent to the voter by the server, and a second step ensuring anonymization of the communication terminal sending the response to the vote to the server, the participation ticket containing at least one piece of data associated with the voter's profile.

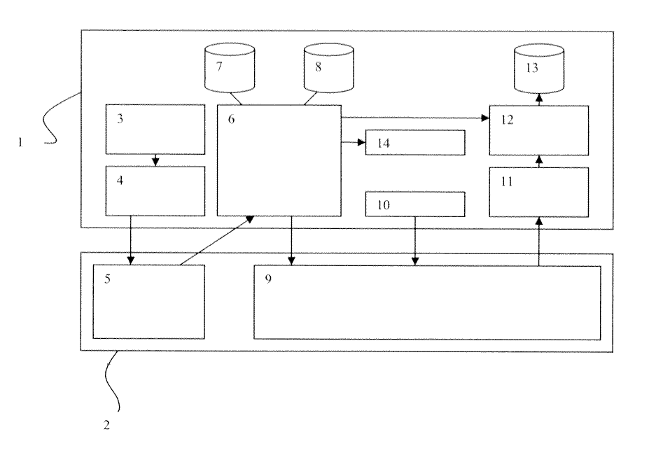

The invention relates to the technical field of telecommunications.

The invention more particularly relates to electronic voting techniques and opinion polling.

Here, “polling” refers to collecting information from part of a target population.

“Opinion polling” refers to the application of polling techniques in order to determine the opinions or likely preferences of the individuals within the target population.

Conventionally, polling institutes prefer the telephone approach. This direct approach is a source of errors for multiple reasons.

First, answering a questionnaire being offered over the telephone requires that the person being polled pay attention, at a time or in an environment that he or she did not choose, such as while at work or in a public place. The person being polled does not necessarily have the time and peace of mind needed to answer the questions naturally.

Second, the people being polled are not necessarily disposed to answer all types of questions honestly. For example, some questions may be seen as indiscreet, such as when they relate to political or religious preferences. Other questions may rightly or wrongly be perceived as lead-ins for telemarketing. Generally speaking, the people being polled may hesitate to answer some questions, if they are not guaranteed anonymity or confidentiality.

Opinion polls or surveys conducted over the Internet, with an incentive to answer, are often perceived as spam or junk mail. The recipients may be wary of opening an unexpected message, which could contain viruses. Furthermore, the results of these polls and surveys may be statistically fraudulent, as one participant may answer multiple times, bypassing a filter based on checking his or her IP address if one is in place.

Electronic Internet voting has been proposed, but it remains tricky to implement, in particular for security reasons (cf. Stephen Mason, Computer Fraud & Security 2004). Electronic voting (e-voting) could increase participation rates, particularly for young people. E-voting would also make it possible to limit proxy votes, provided that any terminal connected to the Internet (including interactive stations) could be used for voting (see Andreas Auer & Alexander Threchsel, Voter par Internet ? Centre d'études et de documentation sur la démocratie directe 2004).

In order to ensure the confidentiality of the electronic vote, multiple techniques have been proposed, such as homomorphic encryption, or the blind signature scheme and mix networks proposed by David Chaum. Only a small number of e-voting software programs have been offered in a commercial version (for a review of these systems, see Bouras et al Telematics and Informatics 20, 2003, pp. 255-274). Vote security implies that nobody can connect a voter with his or her vote. Additionally, only people who are authorized to vote may be permitted to vote, and no voter may be able to vote twice during the same election. Every voter must be able to verify that his or her vote was counted, and no voter may be capable of proving how he or she voted. An example anonymous voting protocol was recently described by Chang et al (An anonymous voting mechanisms based on the key exchange protocol, Computer & security 25, 2006, pp. 307-314).

The restrictions of electronic voting do not make it possible to implement through conventional means of communications offered on the Internet, such as blogs or forums. This is because they do not guarantee voter confidentiality. Additionally, no means are generally implemented to prevent one person from submitting multiple votes.

Surveys, votes, and opinion polls announced on television or radio, however, have long been known. For example, the audience member is invited to call a phone number to express his or her choice, typically an answer to a game. The document WO 01/65849 describes the principle of another possible application: the audience members are invited to express their preferences for how the story will proceed, from among several alternatives.

When the opinion surveys are launched by television or radio, the results are not often usable, for two major reasons.

First, each person may vote multiple times.

Second, assuming that each person has only voted once, the vote only represents the opinions of the people who chose to participate, including on questions which they are not interested in or in which they have no special knowledge. The ability to participate also depends on various factors, and particularly the use of the immediate time when the poll takes place.

To mitigate these difficulties, the document GB 2376101 proposes a method in which the questions that are asked during the poll are established based on prerecorded profiles. These profiles take into account the consumers' decisions to not answer one new question or another.

Electronic voting processes are also known for elections deployed as an interactive television service. The document US 2003/0149616 describes such a method, which has proven unsuitable for conducting opinion polls, particularly for commercial operations. The reason is that regulations prevent any technique that could associate a vote with any of the voter's personal characteristics, such as his or her socio-professional category, age, etc. Complex and burdensome means are provided for ensuring the full anonymity of the vote that is submitted.

The invention aims to provide a technique that makes up for the drawbacks of the prior art.

According to a first object, the invention is intended to disclose an electronic voting, opinion polling or surveying system, such as a satisfaction survey, making it possible to guarantee the confidentiality and anonymity of the data provided by the participants, and also making it possible to ensure that the voters are representative of a target population.

According to a second aspect, the invention is intended to disclose an electronic voting, opinion polling or surveying system, such as a satisfaction survey, of the aforementioned type, which can be used to provide an incentive to participate.

For these purposes, the invention pertains, according to a first aspect, to a method for electronically voting in a questionnaire, comprising:
a step of distributing an electronic voting service offer to a plurality of communications terminals;
a step of sending, from a voter's communication terminal, a request to a remote server, this request containing the voter's authentication information;
a step of authenticating the voter by comparing the authentication information received and saved information associated with the voter;
when the voter has been authenticated, a step of sending the voter's communication terminal a vote participation ticket;
a step of sending to the voting server, containing a response to the questionnaire and the vote participation ticket, which method comprises two steps of anonymization, a first step ensuring the anonymization of the participation ticket sent to the voter by the server, a second step ensuring the anonymization of the communication terminal sending the response to the vote to the server, the participation ticket containing at least one piece of data associated with the voter's profile.

In one embodiment, the participation ticket contains at least one piece of encrypted voter profile data.

In one embodiment, the method comprises a step of creating a questionnaire identification key, said key being sent by the server to the voter's terminal.

Advantageously, the method comprises a step of selecting, among the requests, those which come from the voter meeting a predefined criterion, this selection taking the form of conditional access, or digital rights management.

The invention pertains, according to a second aspect, to a decoder capable of implementing the method as described above, which decoder comprises means for receiving a digital television program by cable or by electromagnetic waves, which decoder further comprises:
means for connecting to a software platform,
means for identifying an interactive electronic voting application adapted to the television program being broadcast,
means for synchronizing that interactive application to said digital program,
means for distributing a signal comprising the digital program and the data specific the interactive electronic voting application that was identified.

The invention pertains, according to a third aspect, to a television broadcast network, which network comprises a plurality of reception terminals each equipped with a decoder as described above, and an electronic voting server, the decoder comprising an electronic voting service selection module and a management module, the server comprising:
a first module, called the creation module, ensuring the generation of the questionnaire,
an electronic services guide generator, adding the electronic voting services to the other interactive television services,
a subscription module performing a comparison between the authentication information received from the selection module with the information saved in the profile databases, the subscription module sending said participation ticket to the management module, when the voter has been identified,
an anonymization module receiving the response to the questionnaire and the vote participation ticket.

Other objects and advantages of the invention will become apparent upon reading the following description of currently preferred embodiments, which will be carried out with reference to the attached drawing.

The following description will be carried out with reference to an implementation of an opinion poll, offered as an interactive television service, on a mobile terminal or via a set-top box, a background in which languages such as NAPEG4-BIFS or MPEG4-LASER (rich media language) make it possible to offer interactive services to users.

The phrase “interactive television” having been used in the state of the art to designate fairly different realities, the following specifications are added here, as needed.

“Interactive television” (ITV) refers to any technology enabling two-way communication between audience members and service providers (such as broadcasters and cable companies), particularly for entertainment, information, education, and business. For example, the applicant has developed an interactive television technology known as AmigoTV enabling the user to share opinions and emotions within a community.

In current interactive television techniques, the viewer may, for example, choose different content from a digital range of offerings, using an electronic program guide (EPG). He or she may also access the Internet from an ad hoc decoder (WebTv).

Interactive television conventionally comprises a back channel enabling the viewer to send the content provider information or requests. Traditional televised content is thereby completed: access to links to website, telecommerce (T-commerce), television on demand, and electronic program guide.

The back channel may be viewed on the television screen (such as by a split screen), with the user communicating by means of his or her remote control and his or her decoder (set top box) or a built-in device, such as IST (Integrated Smart Television).

The reality of the services offered under the name “interactive television” may be presented from two angles: from service content and from the type of interactivity.

With respect to service content, the following may be distinguished:
enhanced television,
participative television,
independent interactive television.

For enhanced television, services are offered as a complement to the broadcast program. Additional information is sent to the viewer, such as through the vertical blanking interval and/or via telephone lines. This additional information may be text, graphics, and fixed images about the programming, the web content activated by triggers, a new audio and video feature, or a custom view (camera angle). For example, the channel Equidia lets subscribers who have a digital terminal connected to a telephone line open an account and make bets from home on all the horse races being broadcast. The information being delivered may or may not be related to the program being broadcast. Enhanced television does not enable communication between people watching the same program.

For participative television, a communication service enables a viewer to interact with the content of a program being broadcast during or outside of broadcast time. For example, the company Tatamia Solutions offers a Tatamia Interactive Channel platform for broadcasting SMSs (Short Message Service) live on the screens. The viewer may, for example, choose the video clip that will be broadcast during a program, and dedicate it while chatting with his or her friends. The viewers may also vote or participate in a contest, such as during so-called reality programs.

An independent interactive television service does not include any main or auxiliary television service. They are mainly transactional services such as home banking or classified ads. The television receiver may also, for example, be used as a terminal for receiving messages between subscribers (for example, TV mail from the company TPS): when a subscriber receives a new message, he or she is automatically notified at the bottom of the screen, when changing channels. The television receiver may also serve as a screen for interactive games offered by a virtual channel.

The invention more particularly pertains to enhanced television and participative television.

It mainly covers interactive television on fixed terminals.

The system diagramed in the attached FIGURE comprises a server 1 and a user device 2, for example a set-top box.

The user device 2 comprises means for receiving generic data from the electronic service guide ESG. In one embodiment, this generic data comes from a digital broadcast network such as DVB-H, DVB-H+, DMB-S. An ESG data syntax is given in the document EP 1791280 for the European digital television standard DVB.

Advantageously, the user device 2 further comprises means for receiving specific data from the ESG, this specific data depending on the user's profile.

Based on the generic data and personalized data received, an updated electronic service guide is obtained. The update may be provided by transmitting data frames modulated on a carrier frequency in a carrousel or endless loop fashion.

A browser enables the user of the device 2 to view the various services which are offered, such as a complement of television programs, and to access these services.

This browser is advantageously connected to a rights management module. Thus, the user of the device 2 is informed of whether or not it is possible to share a service.

The server 1 is equipped with multiple modules.

A first module, known as a creation module 3, ensures the generation of the opinion poll's questions. This creation module 3 also ensures the generation of a poll identification key.

An electronic service guide 4 generator adds the polling services to the other interactive television services. Advantageously, the polling service is limited-access, for example conditional-access. In one variant, digital rights management (DRM) ensures the protection of the service's content with the help of a license server. This digital rights management makes it possible to limit access to the polling service to a specific population. The service's access codes may, for example, be provided to a socio-professional category, or the residents of a given region. Geomarketing data or data mining may be employed to define the profiles of the target population.

In the user device 2, a module 5 enables the selection of the polling service. Whenever a poll is selected by the user, the electronic service guide 4 generator sends the module 5 a poll identification key.

The module 5 then transmits this identification key, as well as the user's authentication, to a subscription module 6.

The subscription module thereby receives a request from the user device 2, for participating in a determined poll.

The subscription module is connected to a database of user profiles 7 and a user location database 8.

From these databases 7, 8, the subscription module advantageously carries out a weighting or adaptation of the poll, in order to build a representative sample of the target population. For example, the representative sample is established using the empirical quota method: based on characteristics whose distribution is known within an entire population, a reduced model of that population is built. The characteristics are chosen as being able to influence the response to the poll.

The subscription module sends a management module 9 a unique participation ticket. This ticket is advantageously anonymous. it enables unique access to the polling service. A server module 10 transmits to the management module a piece of polling content, if need be one adapted to the user profile.

The user's responses and the participation ticket are sent, by the management module 9, to an anonymization module 11. This module protects the confidentiality of the user's data, for example the IP address.

The responses, after entering the anonymization module 11, are transmitted to a collating module 12 to be stored in a database 13.

The subscription module also sends data to a billing module 14 and the collating module 12.

In order to give the viewer an incentive to respond to the poll, several technical measures are advantageously implemented.

First, the poll participation offer is visible for the viewer, during the broadcast of a program whose content corresponds to a polling theme.

In a variant or in combination, participation in the poll is associated with a business offer (such as a bill discount for a service). The subscription module sends information for that purpose to the billing module 14.

In order to ensure the statistical quality of the poll's results, several technical measures are advantageously implemented.

First, the responses to the poll are associated with the viewer's profile, while preserving his or her anonymity. For this purpose, the subscription module 6 sends information about the viewer's profile to the collation module 12. When this collation module receives the responses to the poll, it associates these responses with the viewer's profile, via the anonymous participation ticket. It is thereby possible to weight the responses to the poll. For example, a questionnaire is sent to the viewers of a sporting event. If the representative sample of the target population includes as many men as women, the method makes it possible to detect any under-representation of responses from women.

Second, the anonymous participation ticket is single-use, so the method makes it possible to detect and reject a new poll participation request.

The method may be used for conducting polls, voting, or questionnaires, with or without a direct impact on the programs being broadcast.

The method is compatible with different types of interactivity.

When the interactivity is simulated, the applications and data are integrated into the broadcast video feed, only once or in a loop. The polling service is made available either in real-time when the viewer selects it, or by being stored on the hard drive, which enables local interactivity.

When the interactivity is remote, there is an exchange of data between the broadcaster and the viewer by means of equipment independent of the content distribution network. By way of example, the person being polled sends the responses to the poll over the telephone line to which a decoder is connected.

The invention has several upsides, a few of which are described below.

During an opinion poll, it is possible to maintain a connection between the poll's responses and certain information about the person being polled, while making it impossible to directly associate an opinion with a person.

During an opinion poll, it is possible to target people who will be authorized to answer. Access to the polling service is protected, such as through conditional access or DRM.

To give people an incentive to participate in the polls, several means are possible: electronic coupons for obtaining discounts, access to new interactive services, and subscriptions at special rates, for example.

The anonymity of the people being polled is ensured in particular by masking the terminals' IP source address: the IP requests of a user of the polling service arrive at an anonymizer with one source IP address and leave that anonymizer with a different source address. This anonymization function may be hosted by a trusted site independent of the service provider in charge of managing the polls.

Rich media languages (such as MPEG4-KIFS or MPEGLASER) make it possible to personalize the poll questionnaires, as the users are invited to answer only some questions based on their profiles or their previous answers, for example.

The invention thereby enables an improved use of the polls' results.

1. A method for electronically voting in a questionnaire, comprising:
a step of distributing an electronic voting service offer to a plurality of communications terminals;
a step of sending, from a voter's communication terminal, a request to a remote server, this request containing the voter's authentication information;
a step of authenticating the voter by comparing the authentication information received and saved information associated with the voter;
when the voter has been authenticated, a step of sending the voter's communication terminal a vote participation ticket;
a step of sending to the voting server, containing a response to the questionnaire and the vote participation ticket,
which method is characterized in that it comprises two steps of anonymization, a first step ensuring the anonymization of the participation ticket sent to the voter by the server, and a second step ensuring the anonymization of the communication terminal sending the response to the vote to the server, the participation ticket containing at least one piece of data associated with the voter's profile.

2. An electronic voting method according to claim 1, wherein the participation ticket contains at least one piece of encrypted voter profile data.

3. An electronic voting method according to claim 1, wherein it comprises a step of creating a questionnaire identification key, which key is sent by the server to the voter's terminal.

4. An electronic voting method according to claim 1, wherein it comprises a step of selecting, among the requests, the ones which come from voters meeting a predefined criterion, which selection takes the form of conditional access or digital rights management.

5. A decoder adapted to implement the method as described in claim 1, which decoder is characterized in that it comprises means for receiving a digital television program by cable or over radio waves, which decoder further comprises:
means for connecting to a software platform,
means for identifying an interactive electronic voting application adapted to the television program being broadcast,
means for synchronizing that interactive application to said digital program,
means for distributing a signal comprising the digital program and the data specific to the interactive electronic voting application that was identified.

6. A television broadcast network, which network comprises a plurality of reception terminals each equipped with a decoder, and an electronic voting server, the decoder comprising an electronic voting service selection module (5) and a management module (9), the server comprising:
a first module, called the creation module, ensuring the generation of the questionnaire,
an electronic services guide generator (4), adding the electronic voting services to the other interactive television services,
a subscription module (6) performing a comparison between the authentication information received from the selection module (5) with the information saved in the profile databases, the subscription module sending said participation ticket to the management module (9), when the voter has been identified,
an anonymization module (11) receiving the response to the questionnaire and the vote participation ticket.

7. A broadcast network according to claim 6, wherein the server further comprises a billing module (14), the vote participation being recorded and associated with a commercial offer.
